(19) United States
(12) Patent Application Publication
(10) Pub. No.: US 2006/0211456 A1
(43) Pub. Date: Sep. 21, 2006

(54) Musical audible alert termination

(76) Inventors: Jukka Holm, Tampere (FI); Pauli Laine, Espoo (FI)

Correspondence Address: HARRINGTON & SMITH, LLP, 4 RESEARCH DRIVE, SHELTON, CT, 06484-6212, US

(21) Appl. No.: 10/542,262

(22) PCT Filed: Jan. 17, 2003
(86) PCT No.: PCT/IB03/00536

§ 371 Date: Nov. 25, 2005

(51) Int. Cl. H04B 1/38; H04M 1/00

(52) U.S. Cl. 455/569.1; 455/567; 455/563

(57) ABSTRACT

A mobile telephone terminates the musical audible alert for an incoming call by introducing a replacement musical sequence. The mobile telephone includes audio output means for alerting a user to an incoming call by playing a musical audible alert; a user input for answering an incoming call; and control means, responsive to the user input, for controlling the audio output means to terminate the musical audible alert, wherein the audio output means is operable to terminate the musical audible alert by introducing a replacement musical sequence.

### TECHNICAL FIELD

Embodiments of the present invention relate to musical audible alert termination, in particular the termination of an incoming call alert in a mobile telephone.

### BACKGROUND OF THE INVENTION

WO 02/.32087 describes a mobile telephone having an MPEG music reproduction function. When an incoming call is detected while music is being reproduced, the reproduced music and a ring tone are mixed. The reproduced music is faded-out and the ring tone is simultaneously faded in. When the user answers a call the ring tone is terminated abruptly (FIG. 13B).

There is a trend towards personalizing and customizing mobile telephones. This personalization may involve the replacement of mobile phone covers or the use of personally selected audible alerts for an incoming call (ring-tones).

Mobile telephone users can download a selected audible alert to a mobile phone via e.g. SMS. The audible alert is then stored in the mobile telephone and used to create an audible alert when the phone is receiving an incoming call.

A recent development has been the introduction of polyphony to mobile telephones. The Scalable Polyphony (SP)-MIDI specification defines a mechanism for the flexible presentation of MIDI data to a wide range of playback devices having different polyphony. As a consequence, mobile phones are now able to produce high quality musical audible alerts using a stored Standard Musical Instrument Digital Interface (MIDI) file.

However when the user accepts an incoming call or the user does not answer the phone in time, the audible alert is suddenly stopped. This can be annoying, particularly if the alert is a piece of music e.g. a popular music song or an excerpt from a piece of classical music.

The improvement provided by the mobile telephone's capability to reproduce high quality musical audible alerts is undermined by this problem.

It would be desirable to address this problem.

### BRIEF SUMMARY OF THE INVENTION

According to one embodiment of the present invention there is provided an electronic device, comprising: audio output means for alerting a user by playing a musical audible alert; and control means for controlling the audio output means to terminate the musical audible alert, wherein the audio output means is operable to terminate the musical audible alert by introducing a replacement musical sequence.

According to another embodiment of the present invention there is provided a mobile telephone, comprising: audio output means for alerting a user to an incoming call by playing a musical audible alert; a user input for answering an incoming call; and control means, responsive to the user input, for controlling the audio output means to terminate the musical audible alert, wherein the audio output means is operable to terminate the musical audible alert by introducing a replacement musical sequence.

According to another embodiment of the present invention there is provided a data file comprising a replacement sequence for an electronic device musical audible alert.

According to another embodiment of the present invention there is provided a musical data file, for producing a musical audible alert in an electronic device, comprising a plurality of conditional branching markers each of which is associated with a replacement musical sequence.

According to another embodiment of the present invention there is provided a system, for providing replacement sequences for electronic device musical audible alerts, comprising: a memory storing a plurality of data files each of which comprises a replacement musical sequence for an electronic device musical audible alert; and a server, for downloading a data file from the memory to the mobile telephone, responsive to a request.

According to another embodiment of the present invention there is provided a system, for providing replacement sequences for mobile telephone musical audible alerts, comprising: a memory storing a plurality of musical data files for playing a musical alert, each comprising a plurality of conditional branching markers wherein each of the conditional branching markers is associated with a replacement musical sequence for a mobile telephone musical audible alert; and a server, for downloading a data file from the memory to the mobile telephone, responsive to a request.

According to another embodiment of the present invention there is provided a method of terminating a musical audible alert in an electronic device comprising the step of: replacing an original musical audible alert with a replacement musical sequence.

According to another embodiment of the present invention there is provided a method of answering an incoming call in a mobile telephone, comprising the steps of: detecting that the mobile telephone has an incoming call; starting a musical audible alert; detecting a user input answering the call; and terminating the audible alert by introducing a replacement musical sequence.

Embodiments of the invention prevent the sound reproduction of the phone sounding robotic by avoiding a sudden halt to the musical audible alert. Instead an additional sequence of limited duration is used to bring the musical audible alert to a conclusion. This may maintain an illusion that the music of the audible alert is being played live to the user.

### BRIEF DESCRIPTION OF THE DRAWINGS

For a better understanding of the present invention reference will now be made by way of example only to the accompanying drawings in which:

FIG. 1 is a schematic illustration of a mobile telephone according to one embodiment of the invention;

FIG. 2 illustrates the process 100 that occurs in the mobile telephone 10 when it receives an incoming call;

FIG. 3a illustrates how a musical audible alert may be terminated;

FIG. 3b illustrates how the musical audible alert would have continued if it was not terminated; and

FIG. 4 illustrates the mobile telephone 10 in a cellular radio communications network 50.

### DETAILED DESCRIPTION OF EMBODIMENTS OF THE INVENTION

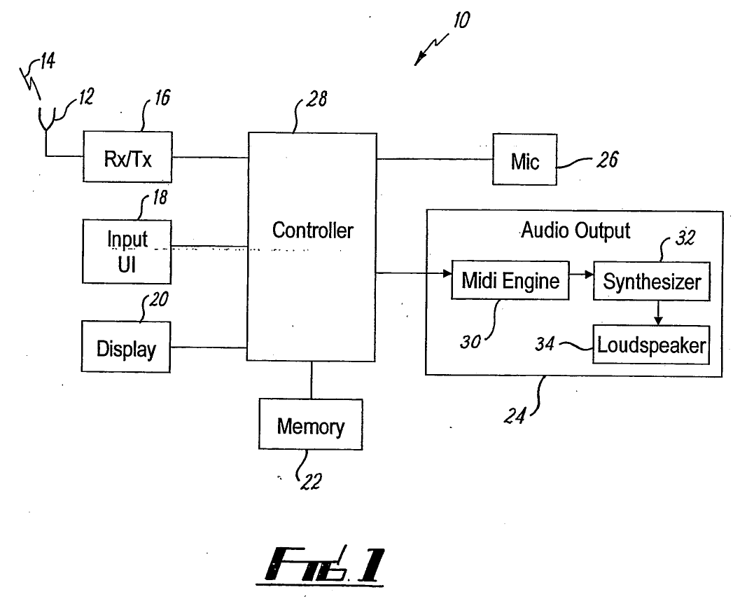

FIG. 1 is a schematic illustration of a mobile telephone 10 according to one embodiment of the invention. The mobile telephone 10 comprises a controller 28, an antenna 12 connected to the controller 28 via a radio transceiver 16, an input user interface (UI) 18 connected to the controller, a display 20 connected to the controller 28, a memory 22 connected to the controller 28, an audio output section 24 connected to the controller, and a microphone 26 connected to the controller 28. This is merely a schematic representation of the mobile telephone 10 and different mobile telephones may have different components and/or different architecture and still operate substantially as described below.

The mobile telephone 10 is capable of communicating 14 in a cellular radio telephone network (not shown) using the radio transceiver 16 and the antenna 12. The mobile telephone 10 is capable of originating telephone calls and terminating telephone calls. When a telephone call for termination at the mobile telephone 10 is received at the network, a control signal is sent to the mobile telephone 10 by the network. This signal is received by the antenna 12 and radio transceiver 16 and processed by the controller 28.

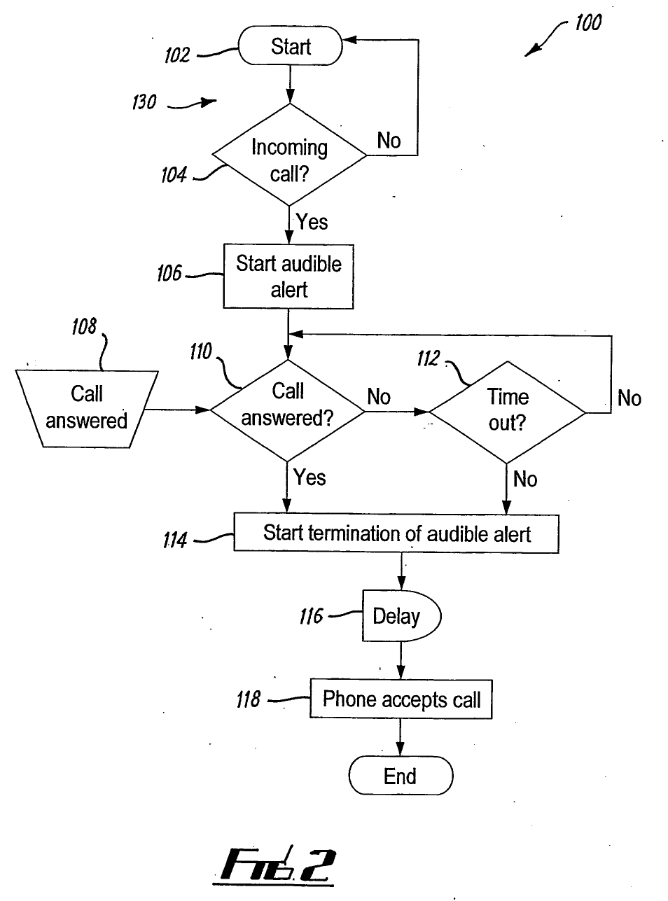

FIG. 2 illustrates the process 100 that occurs in the mobile telephone 10 when it receives an incoming call. The process exits a loop 130 when the controller 28 detects at step 104 that the mobile telephone 10 has received a signal from the network indicating an incoming call. At step 106, the controller 28 controls the audio output section 24 to start producing a musical audible alert. This alerts the user of the mobile telephone 10 to the presence of an incoming call. The controller may also display the name or telephone number of the originator of the telephone call in the display 20.

If the user chooses to answer the incoming call, they do so via the input user interface 18. This is illustrated as the user input step 108 in FIG. 2. The controller 28 detects the user input answering the call at step 110 and starts to terminate the audible alert at step 114.

If the call is not answered, the controller 28 may in some embodiments check at step 112 whether the musical audible alert has been playing for more than predetermined threshold duration i.e. a “time-out”. If the audible alert has timed-out the controller 28 starts to terminate the audible alert at step 114 otherwise it attempts to detect user input answering the call at step 110 while the musical alert is played by the audio output section 24.

After the termination of the audible alert has started at step 114, the controller 28, at step 118, accepts the call. The controller 28 commands the radio transceiver 16 to send an acceptance message to the network, indicating that the call has been accepted. The network then connects the call to the mobile telephone 10 and the microphone 26 is used for voice input by the user and the audio output section 24 is used for voice output to the user.

In some embodiments, the controller 28 may delay, as illustrated at step 116, before accepting the call at step 118. This allows time for the audible call alert to terminate before the call is connected.

Audio output section 24 may be similar to a sound card of a personal computer. It comprises a MIDI engine 30, which is connected to a MIDI synthesizer 32, which is in turn connected to a loudspeaker 34 (or other audio output such as a jack or Bluetooth transceiver for a headset). It some embodiments, the audio output section 24 may also comprise a real time MIDI event scheduler.

The memory 22 stores standard MIDI Files which are transferred by the controller 28 to the audio output section 24. In other embodiments, the audio output section 24 may have direct memory access. There will generally be a separate MIDI file for each musical, audible alert available for playing by the phone. If the user has selected a particular musical alert, then the MIDI file corresponding to that alert is transferred from the memory 22 to the audio output section 24 at step 106 of FIG. 2.

A standard MIDI file includes a series of MIDI messages. The MIDI messages are defined in the MIDI specification. For example, one type of message is used to turn a note on and another type of message is used to turn a note off.

The MIDI engine 30 provides a MIDI data stream in real time (as it is played) to the MIDI synthesizer 32. The MIDI data stream may be taken from the content of a MIDI file transferred to the MIDI engine 30 by the controller 28 (or from memory 22 using DMA) or the MIDI data stream may be created algorithmically by the MIDI engine. The synthesizer 32 may be polyphonic, that is capable of playing more than one note at a time. If high quality music is required a wavetable music synthesizer may be used.

The MIDI synthesizer 32 receives the MIDI messages one at a time and responds to these messages by playing sounds via the loudspeaker 34. The MIDI messages are received and processed by the MIDI synthesizer in real time. When the synthesizer 32 receives a MIDI “Note On” message it plays the appropriate sound. When the corresponding “Note Off” message is received, the synthesizer turns the note off.

The interrupt created at step 110 and at step 112 of FIG. 2, automatically introduces a replacement sequence of music into the musical audible alert. The replacement requence is of limited duration (no more than a few seconds) and brings the musical alert to a non-abrupt conclusion. The MIDI data that produces the audible call alert is processed in real-time by the synthesizer and can therefore be modified easily in real-time.

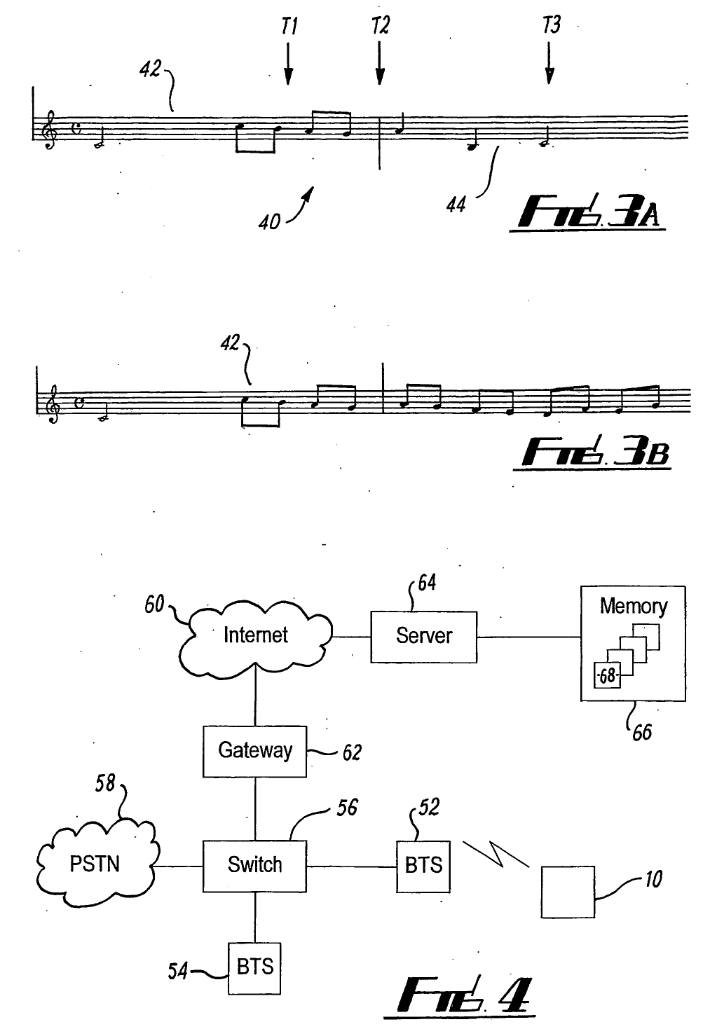

FIG. 3A illustrates how one musical audible alert 40 may be terminated. During the playing of the original musical audible alert 42, an incoming call is detected by the controller 28. The user answers the call at time T1 and the call termination process starts. The phone starts to play a replacement musical sequence 44 at time T2, which may be the same as T1 or later. The replacement musical sequence 44 and the audible alert 40 terminate at time T3. FIG. 3B illustrates how the original musical audible alert 42 would continue if the has not been answered. This is in comparison to prior mobile telephones in which the ringing tone stops abruptly at T1.

The replacement musical sequence 44 may be a pre-determined sequence or a generated sequence.

A pre-determined musical sequence is a piece of music that has been pre-composed and is unchanging. A pre-determined replacement sequence can be stored in a separate replacement MIDI-track. At step 114 of FIG. 2, the start of the termination of the audible alert involves the muting of the original track producing the audible alert and the simultaneous playing of the replacement track. The replacement track can be fetched by a track number or MIDI channel number. This is a fast operation without any delay or glitch in the music played.

The SMF for the original musical alert may have a single pre-determined replacement musical sequence.

Alternatively, the SMF for the original musical alert may have a plurality of pre-determined replacement musical sequences, where each of the plurality of pre-determined replacement musical sequences is associated with a particular portion of the original musical alert. If step 114 occurs during one of these portions, the pre-determined musical sequence associated with this portion is used to replace the original musical audible alert at a pre-determined point in the original musical alert. This can be achieved by incorporating a mechanism for the nonlinear playback of a Standard MIDI File (SMF), and in particular the conditional branching during the playback of a standard MIDI file in the audio output section 24. For example, a series of Marker Meta events (or similar) are embedded in the SMF content to indicate the time position of a desired conditional branch to a destination. The branch is made at that time only if the condition is fulfilled. The condition is that the user has answered an incoming call. The destination is the replacement musical sequence for that portion of the music.

A generated musical sequence is a piece of music that is not wholly pre-composed, although portions of it may be. For example, a predefined musical template may be varied in dependence upon information characterizing the musical qualities of the audible alert at that time. The information may be, for example, tempo or harmonic information. The predefined musical template may be a rhythmic ending (e.g. ta-ta-ta taaaa). Any sampling of the musical audible alert that is required may occur just before the termination of the audible alert is started at step 114. The timing of the transition from the original musical audible alert to the replacement audible musical alert may be controlled using Meta Marker events (or similar) embedded in the SMF.

Another example of a possible generated or pre-determined replacement musical sequence is the variation of the arrangement of the original musical alert e.g. all the melodic instruments could be muted while the percussions continue playing alone or extra instrument could be added.

Another example of a possible generated or replacement musical sequence is a variation of the music. The replacement musical sequence may be, for example, a cadence, a percussion ending or the repetition (one or more times) of a phrase, bar or note(s).

Another example of a possible generated or replacement musical sequence is a variation of tempo e.g. slowing down the original musical audible alert.

Another example of a possible generated or replacement musical sequence is a variation of loudness e.g. fading-out the original musical alert.

It is of course possible to combine two or more of these exemplary endings together e.g. slow down and fade out.

The modification of the audible alert to introduce a replacement sequence may be controlled by the MIDI engine 30. When the original musical audible alert is being played, it is transparent and just passes the received messages to the synthesizer. However, it is capable of modifying and/or replacing the messages sent to the synthesizer. It operates in this mode to control the synthesizer to play the replacement sequence. The scheduler can fade out the original musical audible alert, add new notes/events, take some notes/events away etc.

FIG. 4 illustrates the mobile telephone 10 in a cellular radio communications network 50.

The mobile telephone 10 communicates with one of multiple base stations 52, 54. Each base station is connected to a switch 56 that connects the telephone to the public telephone network 58. In this example, the mobile telephone is Wireless Application Protocol (WAP) enabled and the switch connects to the internet 60 via a gateway 62. The mobile telephone 10 can receive a telephone call from within the network 50 or from or via the public telephone network 58. A server 64 with a memory 66 is located in the internet 60. The server 64 allows the mobile telephone 10 to pull data from the memory 66 in exchange for monetary payment. The data that can be downloaded is one of many MIDI files 68.

In one embodiment, a downloaded MIDI file contains a replacement sequence for a mobile telephone musical audible alert. In another embodiment, the MIDI file contains a musical audible alert for a mobile telephone and one or more replacement musical sequences for terminating the alert. In another embodiment, the MIDI file contains a musical audible alert and a plurality of conditional branching markers within the file. In another embodiment, the MIDI file contains a musical audible alert, a plurality of conditional branching markers within the file and a one or more replacement musical sequences, where each conditional branching marker is associated with one of the replacement musical sequences. None, some or all of the replacement musical sequences may be shared between multiple conditional branching markers.

The MIDI files for download preferably conform to the scalable polyphony (SP) MIDI specification. Although the server and memory are illustratively shown within the internet 60, they may alternatively be located within the cellular network 50 and download MIDI files using multimedia messaging service (MMS).

Although embodiments of the present invention have been described in the preceding paragraphs with reference to various examples, it should be appreciated that modifications to the examples given can be made without departing from the scope of the invention as claimed. For example, although the above described embodiment relates to the termination, in a mobile phone, of a musical audible alert for an incoming call, in other embodiments an electronic device terminates a musical audible alert produced for a different reason in the same manner, by introducing a replacement musical sequence. The electronic device may be a mobile telephone, a personal digital assistant, a computer etc. The musical audible alert may be produced, for example, by an alarm clock or a calendar application.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An electronic device, comprising:
audio output means for alerting a user by playing a musical audible alert; and
control means for controlling the audio output means to terminate the musical audible alert, wherein the audio output means is operable to terminate the musical audible alert by introducing a replacement musical sequence.

2. An electronic device as claimed in claim 1, further comprising a user input, wherein the control means is operable, responsive to the user input, to control the audio output means to terminate the musical audible alert.

3. A mobile telephone as claimed in claim 1, wherein the audio means comprises a synthesizer.

4. A mobile telephone as claimed in claim 3, wherein the synthesizer processes a data stream representative of the musical audible alert in real time.

5. A mobile telephone as claimed in claim 4, wherein audio output means is arranged to vary the data stream in real time to introduce the replacement musical sequence.

6. A mobile telephone as claimed in claim 3, wherein the synthesizer is polyphonic.

7. A mobile telephone as claimed in claim 1, comprising a memory storing a file for producing the musical audible alert.

8. A mobile telephone as claimed in claim 7, wherein the file comprises a series of conditional branch markers, each marker indicating a time for a conditional branch to a replacement musical sequence.

9. A mobile telephone as claimed in claim 1 further comprising radio transceiver means operable for downloading the replacement sequence.

10. A mobile telephone as claimed in claim 1, wherein the replacement sequence is of limited duration and concludes the musical aubile alert.

11. A mobile telephone as claimed in claim 1, wherein the replacement musical sequence is pre-determined.

12. A mobile telephone as claimed in claim 11, wherein the replacement musical sequence is stored in a MIDI-track of a MIDI file.

13. A mobile telephone as claimed in claim 1 wherein the audio output means is operable to terminate the musical audible alert by introducing any one of a plurality of pre-determined replacement musical sequences.

14. A mobile telephone as claimed in claim 13, wherein each of the plurality of pre-determined replacement musical sequences is associated with a particular portion of the musical audible alert.

15. A mobile telephone as claimed in of claim 1, wherein the replacement musical sequence is automatically generated.

16. A mobile telephone as claimed in claim 15, wherein the generated replacement musical sequence is dependent upon information characterizing the musical qualities of the audible alert.

17. A mobile telephone as claimed in claim 1, wherein the replacement musical sequence varies any one or more of: the arrangement of the musical audible alert; the music of the musical audible alert; the tempo of the musical audible alert; and the volume of the musical audible alert.

18. A mobile telephone as claimed in claim 1, wherein the replacement musical sequence fades out the musical audible alert.

19. An electronic device as claimed in claim 1 operable as a mobile telephone.

20. A mobile telephone, comprising:
audio output means for alerting a user to an incoming call by playing a musical audible alert;
a user input for answering an incoming call; and
control means, responsive to the user input, for controlling the audio output means to terminate the musical audible alert,
wherein the audio output means is operable to terminate the musical audible alert by introducing a replacement musical sequence.

21. A mobile telephone as claimed in claim 20, further comprising a radio transceiver wherein the control means, responsive to the user input, controls the radio transceiver, after a delay, to accept the incoming telephone call.

22. A memory embodying a data file comprising a replacement sequence to terminate an electronic device musical audible alert.

23. A memory embodying a data file as claimed in claim 22, the data file further comprising additional replacement sequences.

24. A memory embodying a data file as claimed in claim 22, the data file further comprising a musical audible alert for an electronic device.

25. A memory embodying a data file as claimed in claim 24, the data file further comprising a plurality of conditional branching markers each of which is associated with a replacement musical sequence.

26. A memory embodying a musical data file, for producing a musical audible alert in an electronic device, the musical data file comprising a plurality of conditional branching markers each of which is associated with a replacement musical sequence.

27. (canceled)

28. A system, for providing replacement sequences for terminating electronic device musical audible alerts, comprising:
a memory storing a plurality of data files each of which comprises a replacement musical sequence for terminating an electronic device musical audible alert; and
a server, for downloading a data file from the memory to the mobile telephone, responsive to a request.

29. A system, for providing replacement sequences for mobile telephone musical audible alerts, comprising:
a memory storing a plurality of musical data files for playing a musical alert, each comprising a plurality of conditional branching markers wherein each of the conditional branching markers is associated with a replacement musical sequence for a mobile telephone musical audible alert; and
a server, for downloading a data file from the memory to the mobile telephone, responsive to a request.

30. A method of terminating a musical audible alert in an electronic device comprising the step of:
replacing an original musical audible alert with a replacement musical sequence.

31. A method of answering an incoming call in a mobile telephone, comprising the steps of:
detecting that the mobile telephone has an incoming call;
starting a musical audible alert;
detecting a user input answering the call; and
terminating the audible alert by introducing a replacement musical sequence.

32. (canceled)

33. (canceled)
